(19) United States
(12) Patent Application Publication
(10) Pub. No.: US 2005/0121643 A1
(43) Pub. Date: Jun. 9, 2005

(54) Lighter with improved thermodynamics

(75) Inventor: Chi Ming Lam, Quarry Bay (HK)

Correspondence Address: MERCHANT & GOULD PC, P.O. BOX 2903, MINNEAPOLIS, MN, 55402-0903, US

(73) Assignee: Tak Chi SHER, Quarry Bay (HK)

(21) Appl. No.: 10/504,102

(22) PCT Filed: Mar. 4, 2002
(86) PCT No.: PCT/US02/06357

(51) Int. Cl. F16K 1/00

(52) U.S. Cl. 251/359

(57) ABSTRACT

A lighter valve seat member (8) having a cylinfrical member (21), having an internal bore (22), a rebate in the bore to provide a larger diameter bore part (23) and a smaller diameter bore part (24) which forms a valve seat (25). The cylindrical member has an external cylindrical face and a stop is formed on the external face. The external diameter of the cylindrical between the stop and the end of the cylindrical member providing the larger diameter bore part end is substantially constant. A sealing O-ring (14) is held between the stop and a housing (13) into which the cylindrical part of the valve seat member is positioned.

### FIELD OF THE INVENTION

This invention relates to a valve seat member forming part of a lighter such as a cigarette lighter.

### BACKGROUND OF THE INVENTION

Usually a lighter's valve involves three functions:

First to provide closure of the reservoir from where the lighter takes its fuel supply, secondly to allow opening and closing of the gas flow which correspond to the conditions of ignited and extinguished, and thirdly to control the gas flow to provide a flame of practical use (generally a gas flow of about 1 mg/second giving a 20 mm flame height).

The first two functions have been used for approximately the last 30 years, both widely and substantially unchanged. The design of these functions is strong and convenient.

ISO 9994 is an International Standard which identifies a large set of defects related to the consequences of a poor flow and evaporation control (flame changes over short and long intervals, flame dependence on the room temperature, spitting, sputtering, flaring, etc), and warning against and forbidding the production and sale of lighters with such defects.

It is well known that to reduce the pressure of the fuel from the high value it is subject to inside the reservoir (15-70 Mpa) to the almost null value (atmospheric pressure) at the nozzle tip, and to restrain the flow to the desired value of 1 mg/second approximately, the fuel is forced to circulate through a narrow path or a set of such paths. The prior art describes different solutions as fibrous or micro-porous filters subject to compression (by turning the adjusting screw), fixed flow membranes, sinterzised material, capillary tubes, and other constructions.

The movement of the fuel through these paths is ruled by hydrodynamic considerations, involving pressure velocity and viscosity, and also more general thermodynamic considerations since the fuel expansion involves some work that modifies the energy balance of the system and additionally the phase change required of the supply of a well defined amount of energy, known as latent heat of evaporation. From a theoretical point of view, these are summarised by the Gibbs formulas' regarding energy, entropy and enthalpy, and for the Clapeyron expression regarding phase change.

$$\begin{matrix}\begin{matrix}dU = TdS - Pd V \\ dH = TdS + VdP\end{matrix} & \begin{matrix}du = Tds - Pdv \\ dh = Tds + vdP\end{matrix} & \frac{dP}{P}\end{matrix} = \frac{lu}{R} \frac{dT}{{T}^{2}}$$

Thus the energy balance is critical, and its first consequence is changes in the system temperature (“T” is present in all the formulas). As for a LPG (liquefied petroleum gas) the vapour pressure and the viscosity are a direct function of the temperature, is clear that care must be taken with the energy balance or there is a high risk that the system will become unstable. The consequences of such instability are those referred to in the ISO 9994 defects lists, explicitly flame changes, spitting, sputtering, flaring, etc.

Broadly the components of the invention are all those parts that are able to deliver or drag energy from the construction that is: flame, fuel, all the components of the valve and the lighter's structure.

To keep the phase change (evaporation of fuel from liquid to gaseous stage) working well, energy must be supplied to the system. Of course the fuel combustion , i.e. the flame, will deliver a substantial amount of energy (much bigger than the requirements for phase change) but this energy is supplied quite a distance from the area where phase change is occurring.

When the valve is opened and the gas begins flowing, the system passes through two different states: a transitory state and a stationary state. The transitory state may last up to five seconds, and then the stationary state will last until flame extinction.

In the transitory state, besides the need to supply energy to evaporate the fuel to give the standard flow (1 mg/sec., approximately), some captive liquefied fuel accumulated at the top part of the lighter between the dosage means (i.e. filters, wicks etc) and the flow stop means must be evaporated (see FIG. 7). Since the effect of the combustion is not yet available, there is no external source of energy supply available, and the resources available inside the system must be used. This can be achieved by taking some heat from the components, cooling them, and then transferring the heat to the dosage means.

In the stationary state, extra heat is no longer needed as no substantial amount of liquid fuel remains. Thus the amount of energy required is obtainable from the combustion (heating the nozzle and adjacent areas mostly by radiation) passing through the nozzle and warming the dosage means. The heat transferred by the nozzle must be sufficient but not excessive. Otherwise the whole system may become too hot and the parts may melt together when the lighter is ignited for a long time. Standard presently available constructions are suitable for this part of the construction.

This invention relates to the first 0.5 seconds of the transitory state. Some captive liquefied fuel will accumulate between the T-Pin and the T-Packing each time the flow is stopped because of the equilibrium of pressure inside the lighter and some of the fuel accumulated in the liquid dead volume area (28 in FIG. 7) must be evaporated. The fuel accumulated at 24 of central bore 22 will evaporate first suddenly since it has an open escape way. The fuel left in the other parts of the liquid dead volume area 28 will then evaporate more slowly, since it must flow a short way through the dosage means up to the exit. What limits or controls this evaporation speed is the temperature of the parts in contact with the liquefied fuel, that is, the evaporation interface. The hotter this part is, the faster the evaporation will be. Such captive liquified fuel will accumulate each time the fuel flow is stopped as pressure each side of the filter will equalise and the vapour will liquefy.

If the captive liquefied fuel could be eliminated, the transitory state would vanish, and only the stationary state would need to be considered. Unfortunately, for engineering reasons (tolerances of the components, assembly feasibility, strength of materials, etc.), the amount of captive liquefied fuel cannot be substantially reduced.

The consequence of the quick evaporation of such captive liquefied fuel in prior art designs is a sudden increase in the flow in the first 0.1 second after the valve is opened (see FIG. 8). Igniting this gas fuel stream gives a flame height around 100 mm, that is 5-10 times more than the required flame. Fortunately there is some 0.3 seconds delay between the flow opening and the flame ignition, and the practical effect of this is that the flame cannot be seen since the air fuel blend is very good and the flame is a blue colour with poor luminescence.

A second practical effect is an excessive rate of ignition failures. In the case of flint lighters, many times the sparks produced after rubbing the flint do not ignite the gas stream due to the excessive speed of the gas stream. In the case of Piezo electric lighters or electronic lighters, as there is a single spark which has lower energy content, the rate of ignition failures at the first strike is much higher, reaching 50% in many lighters.

A third practical effect of quick evaporation is the temperature drop of the dosage means. Many times the LPG blend includes n-butane, with an evaporation temperature of −0.5° C. If any of the components of the dosage means shows a temperature lower than those −0.5° C., the consequence is that the n-butane is not evaporated and small droplets of liquid fuel are formed. The name of this phenomena is flaring and is clearly described in ISO 9994. In cases where droplets evaporate inside the nozzle, there will be sudden changes in flame height commonly known as flickering.

It can be clearly appreciated that none of these outcomes of the captive liquefied fuel are desirable. Up until today all the efforts have been addressed to eliminate or evaporate the captive fuel as soon as possible, in the hope that the negative outcomes are reduced or eliminated.

### OBJECT OF THE INVENTION

It is therefore an object of the present invention to provide a lighter valve seat member and/or a lighter valve seat member and a housing and/or a lighter which will go at least some way towards obviating or minimising the foregoing disadvantages and/or meeting the foregoing desiderata or which will at least provide the public with a useful choice.

### SUMMARY OF THE INVENTION

In one aspect the invention consists in a lighter valve seat member comprising a cylindrical member having an internal bore, a rebate in the bore to provide a larger diameter bore part and a smaller diameter bore part, and to form a valve seat, the cylindrical member having an external cylindrical face, and a stop formed on the external face, the external diameter of the cylindrical member between the stop and the end of the cylindrical member providing the larger diameter bore part end being substantially constant.

Preferably the stop comprises an annular flange.

Preferably the annular flange is positioned at or adjacent the end of the cylindrical member providing the smaller diameter bore part end.

Preferably the volume of material forming the valve seat member is in the range 8-30 mm³.

Preferably the ratio of the external diameter of the cylindrical member to the external diameter of the flange is in the range 0.5-0.9.

Preferably the ratio of the internal diameter of the larger part of the bore to the external diameter of the cylindrical member is in the range 0.65-0.9.

Preferably the ratio of the overall length of the cylindrical member to the external diameter of the cylindrical member is in the range 0.8-1.4.

Preferably the ratio of the maximum thickness of the flange to the overall length of the cylindrical member is in the range 0.085-0.2.

Preferably the specific heat of the material forming the cylindrical member is in the range 200-1000 J/Kg/° K.

Preferably the thermal conductivity of the material comprising the cylindrical member is in the range 75-450 W/m/° K.

Preferably the cylindrical member is made by cold forming.

Preferably the cylindrical member is made by die casting.

Preferably the cylindrical member is made by any one of stamping and embossing.

Preferably the cylindrical member is made by turning on a lathe.

In a further aspect the invention consists in a lighter valve seat member and a housing; the valve seat member being as claimed in claim 1, and the housing comprising a member having an internal bore, dimensions to receive at least part of the external face of the valve seat member, a rebate in the bore of the housing against which the inserted end of the valve seat member can bear, the rebate being positioned so that a gap is provided between the flange of the valve seat member and the adjacent end of the housing.

In a still further aspect the invention consists in a lighter including a valve seat member as claimed in claim 1.

In a still further aspect the invention consists in a lighter including a valve seat member and a housing as described above.

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

### BRIEF DESCRIPTION OF THE DRAWINGS

On preferred form of the invention will now be described with reference to the accompanying drawings in which,

FIG. 1 is cross-sectional view through part of the valving mechanism of a prior art lighter,

FIG. 2 is a view as in FIG. 1 of a valving mechanism of a lighter according to one preferred form of the invention,

FIG. 3 is an exploded view of part of the valving mechanism of a prior art lighter,

FIG. 4 is an exploded view as in FIG. 3 of a lighter according to a preferred form of the invention,

FIG. 5 is a cross-sectional view of a valve seat member according to a prior art lighter,

FIG. 6 is a view as in FIG. 5 of a valve seat member according to one preferred form of the invention,

FIG. 7 is an enlarged view of a valve seat member according to one preferred form of the invention in the valve mechanism of a lighter,

FIG. 8 is a graph of temperature v time on striking of a prior art lighter, and

FIG. 9 is a graph as for FIG. 8 for a preferred embodiment of the invention.

### DESCRIPTION OF THE PREFERRED EMBODIMENT

Referring to the drawings the present invention considers controlling excessive evaporation speed. The primary improvements we expect is to attenuate the three negative effects listed hereinbefore.

Many matters involving design and physical properties are comprised in the transitory state. There are:
LPG compositions, since usually lighters are filled with a blend of low hydrocarbons, showing different boiling temperatures, different latent heat of evaporation, and in different viscosities.
Room temperature, since this gives the measure of the amount of energy accumulated in the valve system, just before opening flow, and ready to be transferred to the LPG to evaporate.
Specific heat of the materials involved in the valve system structure. Usually plastics polymers show poorer specific heat than metals (J/Kg° C.).
Heat transfer rate co-efficient, evaluating the speed of heat transfer through the components surrounding the evaporation interface. This is much higher in metals than in plastics polymers (J/m/m²/sec/° K.).
Mass and design of those pieces surrounding the evaporation interface. The bigger, more massive and thicker walled these pieces are, the faster they can deliver heat to the required points.

Most of these matters cannot be changed in mass production and low priced goods. However the last matter can be the subject of modifications.

According to prior art, the components of the evaporation means must be as massive and accumulate as much energy as possible to allow quick evaporation. In particular the valve seat member is usually made of brass (high weight and high specific heat), and the walls are thick and massive to allow a quick heat transfer to the evaporation interface area.

Our approach to controlling the evaporation of the captive liquefied fuel is to reduce the weight of one of the components of the evaporation means and therefore the accumulated heat is reduced, and to modify its design so that the heat supply is more regular and progressive. A suitable component is the valve seat member. One way to achieve this modification is to make the walls of the valve seat member thinner. The speed of heat transfer is a function of distance, temperature difference and the surface of the conductive means. The heat transfer rate value can be formulated as W/M/m²/° K. or W/m/° K.

It is very difficult if not impossible to formulate a global equation to monitor the hydrodynamic and thermodynamic behaviour of the system of the invention to get a direct answer as to what is the most convenient design and choice of materials for a revised valve seat member. An alternative method is to use finite elements modelling (FEM) calculations, which involves some simplifications and large computer usage. However, although (FEM) is a very powerful tool, and is very suitable for analysing stationary states, it is not suitable for transitory state phenomena

Our approach has therefore been to determine empirically by laboratory research, sensing and measuring flows, temperatures and pressures of a large collection of embodiments of the required construction.

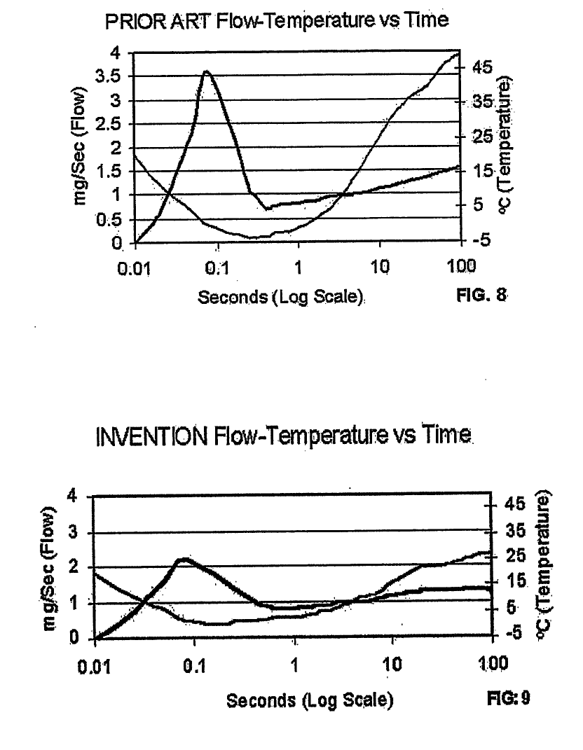

The results are shown in FIG. 9 (at 25° C., which can be compared to the same table for prior art behaviour in FIGS. 8).

We have obtained a lower flow peak value (around 60% of the prior art peak value) and a smaller peak-to-peak value of the temperature change in the interval. Also the final flow after 100 seconds operation is nearer to the 1 mg/sec. target than in the previous art embodiments.

An additional advantage is that we are saving some raw material since the valve seat member of our invention is smaller, and maybe more importantly, it is suitable for mass production by methods such as cold forming, stamping, embossing, or die casting in addition to the more conventional and expensive lathing process, which was the only process suitable for the valve seat members of the prior art.

Aluminium seems to be the most suitable material to make the valve seat member from. This is because it has high heat conductivity, high specific heat, is easy to shape by cold forming, stamping or the like and also has suitable mechanical properties for our construction. We have tested and found suitable results for other common materials. The reason is that the product of the specific heat by density moves through a relatively narrow range, and our design is quite robust.

| | | Density | Thermal Conductivity |
|---|---|---|---|
| Element | Specific Heat (J/Kg/° K) | (Kg/m3) | (W/m/° K) |
| Al | 900 | 2700 | 237 |
| Cu | 385 | 8960 | 401 |
| Zn | 388 | 7140 | 116 |
| Fe | 272 | 8900 | 80 |

We found the following ratios as specially suitable for the purposes of our invention:
Total volume of the valve seat member: Range 8-30 mm³ (prior art is 50 mm³, preferred value for the present invention is 16.7 mm³)
D2/D1 Rate: Range: 0.5-0.9 (prior art is 1, preferred value for the present invention is 0.725)
D3/D2 Rate: Range 0.65-0.9 (prior art is 0.55, preferred value for the present invention is 0.76)
H1/D1 Rate: Range 0.8-1.4 (prior art is 1.7, preferred value for the present invention is 1)

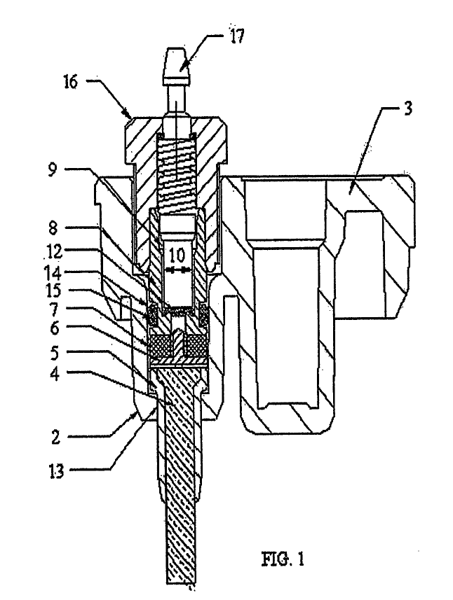

FIG. 1 shows a prior art mechanism wherein an extended part 2 of the fuel tank cover 3 holds a wick 4. The wick is retained in a wick holder 5 held in position by a “T” pin 6 onto which is positioned a filter 7.

A valve seat member 8 is provided which has a longitudinal bore 9 therein which has a larger diameter end 10 and a smaller diameter end 11 so that the step or rebate therein is able to provide the valve seat 12.

The valve seat member 8 is sealed to a housing 13 by means of an “O” ring 14 which is retained in a groove 15 towards one end of the valve seat member 8.

The valve seat member 8 is retained in position by means of a housing 16 through which the nozzle 17 of the lighter extends.

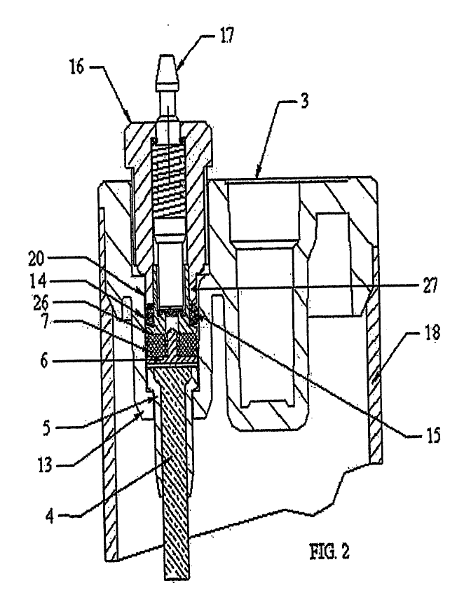

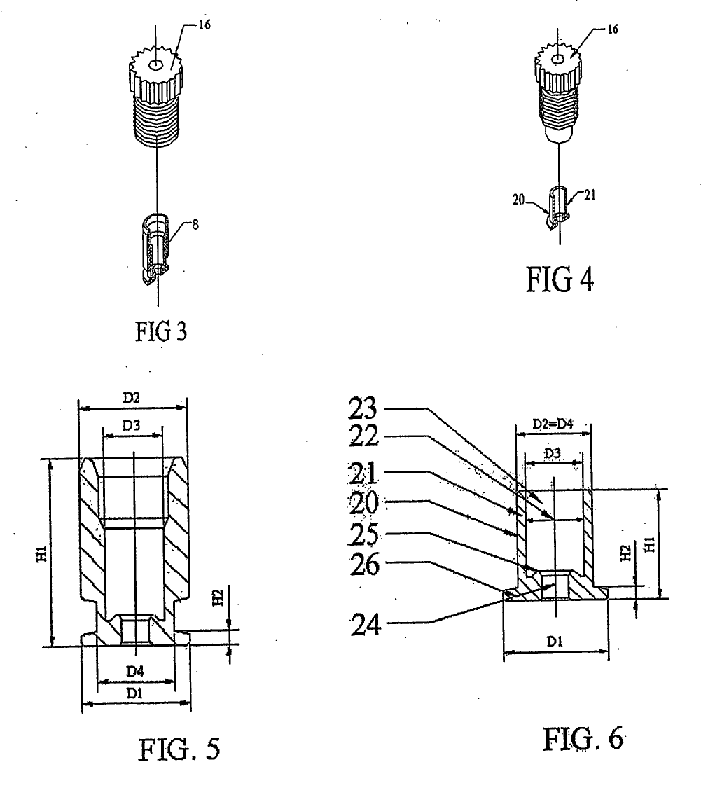

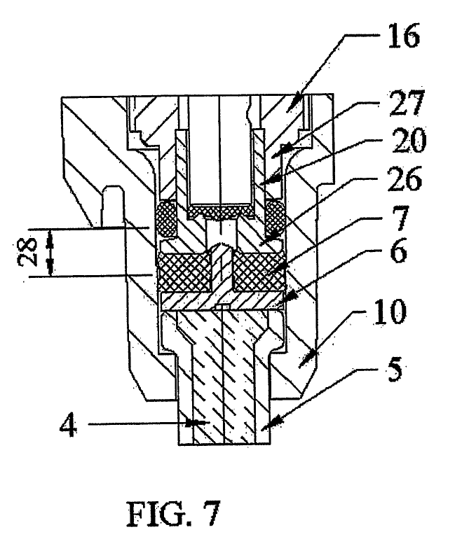

In the preferred form of the invention shown in FIG. 2 the tank cover 3 engages a tank indicated at 18. The construction also includes suitable lifting mechanisms and the like but these may be of substantially known construction and therefore are not shown in the drawings for clarity purposes.

Again a wick 4 is held in the wick holder 5 with a T-Pin 6 and filter 7 as above described.

The valve seat member 20 is provided by a cylindrical member 21 and which is of substantially constant external diameter. The central bore 22 has a larger diameter part 23 and a smaller diameter part 24 so that the rebate so formed forms a valve seat 25 substantially as above described.

However a stop preferably in the form of a circumferential flange 26 is provided on the outer surface of the cylindrical member 20. The flange 26 is preferably provided at the end of the cylindrical member 21 which provides the opening for the smaller end 24 of the bore 22.

The “O” ring 14 is held between the flange 26 and a cylindrical extension 27 on the housing 16. Sealing between the valve seat member 20 and the housing 12 is therefore retained.

In the preferred form of the invention the volume of material, for example, aluninium, copper, zinc or iron from which the valve seat member 20 is formed is preferably in the range of substantially 8-30 mm³.

In relation to other structural ratios of the valve seat member 20, the ratio of the external diameter of the cylindrical member (D2, D4) to the external diameter of the flange (D1) is desirably in the range of 0.5-0.9.

The ratio of the internal diameter of the larger part of the bore (D3) to the external diameter of the cylindrical member (D2) is desirably in the range 0.65-0.9.

The ratio of the overall length of the cylindrical member (H1) to the maximum external diameter of the cylindrical member (D1) is preferably in the range of 0.8-1.4.

Further the ratio of the maximum thickness of the flange (H2) to the overall length of the cylindrical member (H1) is desirably in the range of 0.085-0.2.

The material from which the valve seat member is formed preferably has a specific heat in the range of 200-1000 J/Kg/° K. of which aluminium is a suitable such material. The thermal conductivity of the material of the cylindrical member is also desirably in the range of 75-450 W/m/° K.

In use the lighter is operated as for the prior art lighters.

Thus it can be seen that at least in the preferred forms of the invention constructions are provided which allow the mass of the valve seat member to be reduced and allow less expensive construction techniques including mass production to be used if desired whilst improving the performance of the lighter. Furthermore the invention enhances the thermodynamic phenomena that occurs when moving fuel from its liquid state inside the reservoir, to the vapour state so that proper burning is achieved at the tip of the nozzle. The supply of heat from the nozzle is made more regular and progressive. Furthermore the “O” ring 13 is more easily positioned during manufacture.

1. A lighter valve seat member comprising a cylindrical member having an internal bore, a rebate in the bore to provide a larger diameter bore part and a smaller diameter bore part, and to form a valve seat, the cylindrical member having an external cylindrical face, and a stop formed on the external face, the external diameter of the cylindrical member between the stop and the end of the cylindrical member providing the larger diameter bore part end being substantially constant.

2. A lighter valve seat member as claimed in claim 1, wherein the stop comprises an annular flange.

3. A lighter valve seat member as claimed in claim 2, wherein the annular flange is positioned at or adjacent the end of the cylindrical member providing the smaller diameter bore part end.

4. A lighter valve seat member as claimed in claim 1, wherein the volume of material forming the valve seat member is in the range 8-30 mm³.

5. A lighter valve seat member as claimed in claim 1, wherein the ratio of the external diameter of the cylindrical member to the external diameter of the flange is in the range 0.5-0.9.

6. A lighter valve seat member as claimed in claim 1, wherein the ratio of the internal diameter of the larger part of the bore to the external diameter of the cylindrical member is in the range 0.65-0.9.

7. A lighter valve seat member as claimed in claim 1, wherein the ratio of the overall length of the cylindrical member to the external diameter of the cylindrical member is in the range 0.8-1.4.

8. A lighter valve seat member as claimed in claim 1, wherein the ratio of the maximum thickness of the flange to the overall length of the cylindrical member is in the range 0.085-0.2.

9. A lighter valve seat member as claimed in claim 1, wherein the specific heat of the material forming the cylindrical member is in the range 200-1000 J/Kg/K° K.

10. A lighter valve seat member as claimed in claim 1, wherein the thermal conductivity of the material comprising the cylindrical member is in the range 75-450 W/m/° K.

11. A lighter valve seat member as claimed in claim 1, wherein the cylindrical member is made by cold forming.

12. A lighter valve seat member as claimed in claim 1, wherein the cylindrical member is made by die casting.

13. A lighter valve seat member as claimed in claim 1, wherein the cylindrical member is made by any one of stamping and embossing.

14. A lighter valve seat member as claimed in claim 1, wherein the cylindrical member is made by turning on a lathe.

15. A lighter valve seat member and a housing; the valve seat member being as claimed in claim 1, and the housing comprising a member having an internal bore, dimensions to receive at least part of the external face of the valve seat member, a rebate in the bore of the housing against which the inserted end of the valve seat member can bear, the rebate being positioned so that a gap is provided between the flange of the valve seat member and the adjacent end of the housing.

16. A lighter including a valve seat member as claimed in claim 1.

17. A lighter including a valve seat member and a housing as claimed in claim 15.
